(19) United States
(12) Patent Application Publication
(10) Pub. No.: US 2005/0064741 A1
(43) Pub. Date: Mar. 24, 2005

(54) Connecting device

(76) Inventors: Atsushi Nishio, Tokyo (JP); Takashi Kawasaki, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/880,085

(22) Filed: Jun. 30, 2004

(30) Foreign Application Priority Data
Sep. 19, 2003 (JP) P.2003-328726
Sep. 19, 2003 (JP) P.2003-328728

(51) Int. Cl. H01R 12/00

(52) U.S. Cl. 439/69

(57) ABSTRACT

A connecting device includes a first circuit board having a first conductive pattern on an outer peripheral edge portion thereof, a second circuit board having a second conductive pattern on an outer peripheral edge portion thereof, and a connector having a terminal corresponding to the first and second conductive patterns. The terminal connects the first conductive pattern and the second conductive pattern when the first and second circuit boards are attached to the connector. Also, a connecting device includes a first circuit board having a first conductive pattern on an edge portion thereof, a second circuit board having a second conductive pattern on an edge portion thereof, and a connector having a first and second faces, the first and second faces have a first and second recess portions respectively. A terminal connects the first and second conductive patterns when the first and second circuit boards are attached to the first and second recess portions respectively.

### BACKGROUND OF THE INVENTION

This invention relates to a connecting device, and more particularly to a connecting device for circuit boards in which an assembling process is simplified by obviating the need for a soldering operation.

Also, this invention relates to a connecting device, and more particularly to a connecting device for circuit boards which enables the design of circuits to be made easily.

In a related connecting device for circuit boards shown in FIGS. 12 to 16, patterns 2 are printed on one aide portion of one circuit board 1, and terminals 4 of a female-type connector 3 are soldered respectively to the patterns 2, so that this connector is fixed to the circuit board. Like the circuit board 1, patterns 6 are provided at one side portion of the other circuit board 5, and terminals 8 or a male-type connector 7 are soldered respectively to the patterns 6, so that the male-type connector 7 is fixed to the circuit board 5.

When the male-type connector 7 is fitted into the female-type connector 3, the one circuit board 1 and the other circuit board 5 are electrically connected together (see, for example, JP-A-2000-260507).

In JP-A-2000-260507, the male-type connector 7 and the female-type connector 3, mounted respectively on the associated circuit boards 1 and 5 by soldering, are fitted together. As a result, the two circuit boards 1 and 5 can be electrically connected together. However, since these connectors 3,7 are mounted respectively on the associated circuit boards 1 and 5 by soldering, the assembling operation is complicated, and this has lowered the efficiency of the circuit board-mounting operation.

Also, in JP-A-2000-260507, each of the male-type connector 7 and the female-type connector 3 is soldered to the patterns formed in a concentrated manner on the one aide portion of the corresponding circuit board, and by fitting the male-type connector 7 and the female-type connector 3 together, the circuit boards 1 and 5 can be electrically connected together. However, the patterns must be formed in a concentrated manner at the one side portion or each circuit board, the design of the circuits has been much limited.

### SUMMARY OF THE INVENTION

It is therefore a first object or the present invention to provide a connecting device for circuit boards capable of simplifying the assembling operation required for connecting the circuit boards to enhance the efficiency or the operation.

Also, a second object of the present invention is to provide a connecting device for circuit boards capable of simplifying the design of the circuit boards to enhance the efficiency of the operation.

In order to achieve the above object, according to the present invention, there is provided a connecting device, comprising:
a first circuit board, which has a first conductive pattern on an edge portion thereof;
a second circuit board, which has a second conductive pattern on an edge portion thereof; and
a connector, which includes a first face and a second face opposed to the first face, the first face and second face having a first reels portion and a second recess portion respectively,
wherein a terminal is provided in the first and second recess portion; and
wherein the terminal connects the first conductive pattern and the second conductive pattern when the first circuit board and the second circuit board are attached to the first recess portion and the second recess portion respectively.

Preferably, each of the first recess portion and the second recess portion has at least two sides. A plurality of the terminals of the connector are arranged along the at least two sides.

Preferably, the connector has a step portion which prevents from insertion of the first and second circuit boards in a reverse state to the first and second recess portions.

Preferably, a thickness of each of the first and second recess portion is greater than that of each of the first and second circuit boards.

Preferably, each or the first and second circuit boards has a two linear sides which are faced with to each other and curved aides which are connected to the linear sides.

Preferably, the connector has a fixing member which fixes the first and second circuit boards to the connector.

Preferably, the fixing member is provided as a cover member. The cover member is slidably provided on an end portion of the connector. The covers slides between an open position and a closed position. When the cover member is positioned at the open position, the cover member allows the first and second circuit boards to attach to the connector. When the cover member is positioned at the closed position in a case that the first and second circuit board are mounted on the connector, the cover member fixes the first and second circuit boards to the connector.

Preferably, the cover member covers the first and second conductive patterns of the first and second circuit boards when the cover member is positioned at the closed position.

In the above configurations, the recess portions, corresponding in shape to the circuit boards to which the connector is connected, are formed respectively in the front and back sides or the connector, and these recess portions are so formed that the circuit boards can be fixed to the recess portions, respectively. The conductive patterns arc provided at the outer edge portion of each of the circuit boards so an to be press-contacted respectively with the terminals mounted at the recess portions of the connector.

Therefore, when the circuit boards are fixed to the recess portions of the connector, respectively, the circuit boards, provided respectively at the opposite (front and back) sides of the connector, are electrically connected together via the terminal of the connector. Therefore, the soldering operation for soldering each connector to the corresponding circuit board and the positioning operation for the purpose of fitting the male-type and female-type connectors together as in the related construction are not necessary. Therefore, the efficiency of the assembling operation for the purpose of electrically connecting the circuit boards together is enhanced, and besides the required labor is reduced, and this also contributes to the reduction of the cost.

According to the present invention, there is also provided a connecting device comprising:
a first circuit board, which has a first conductive pattern on an outer peripheral edge portion thereof;
a second circuit board, which has a second conductive pattern on an outer peripheral edge portion thereof; and
a connector, which has a terminal corresponding to the first and second conductive patterns,
wherein the terminal connects the first conductive pattern and the second conductive pattern when the first circuit board and the second circuit board are attached to the connector.

In the above configuration, the conductive patterns are provided at the outer peripheral edge portion of each of the first and second circuit boards, and these patterns can be press-contacted with the terminal of the connector, respectively. Therefore, as compared with the related construction in which the patterns are formed in a concentrated manner at the one side portion of each circuit board, the degree of freedom of the circuit design is enhanced, so that the circuit boards can be simplified, and this also contributes to the reduction of the cost. There is another advantage that a small-size design of the circuit boards can be efficiently achieved since the edge portion of each circuit board is utilized.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is an exploded, perspective view of a connection device for circuit boards according a first embodiment of the present invention;

FIG. 2 is a plan view or a first circuit board;

FIG. 3 is a view showing a back side of the first circuit board;

FIG. 4 is a plan view of a second circuit board;

FIG. 5 is a view showing a back side of the second circuit board;

FIG. 6 is an enlarged, vertical cross-sectional view of an important portion, showing the manner or fixing the first and second circuit boards to a connector;

FIG. 7 is an enlarged, vertical cross-sectional view of the important portion, showing a condition in which the first and second circuit boards are fixed to the connector;

FIG. 8 is a perspective view showing a connector according to a second embodiment of the present invention;

FIG. 9 in an enlarged, vertical cross-sectional view of an important portion of the second embodiment;

FIG. 10 is an enlarged, vertical cross-sectional view of an important portion or the second embodiment, showing the manner of fixing circuit boards to the connector;

FIG. 11 is an enlarged, vertical cross-sectional view of the important portion of the second embodiment, showing a condition in which the first and second circuit boards are fixed to the connector;

FIG. 12 is an exploded, perspective view of a related connecting device for the circuit board;

FIG. 13 is a plan view of a circuit board of the related device;

FIG. 14 is a view showing a back side of the circuit board of the related device;

FIG. 15 is a plan view of the other circuit board of the related device; and

FIG. 16 in a view showing a back side of the other circuit board of the related device.

### DETAILED DESCRIPTION OF THE PREFERRED EMBODIMENTS

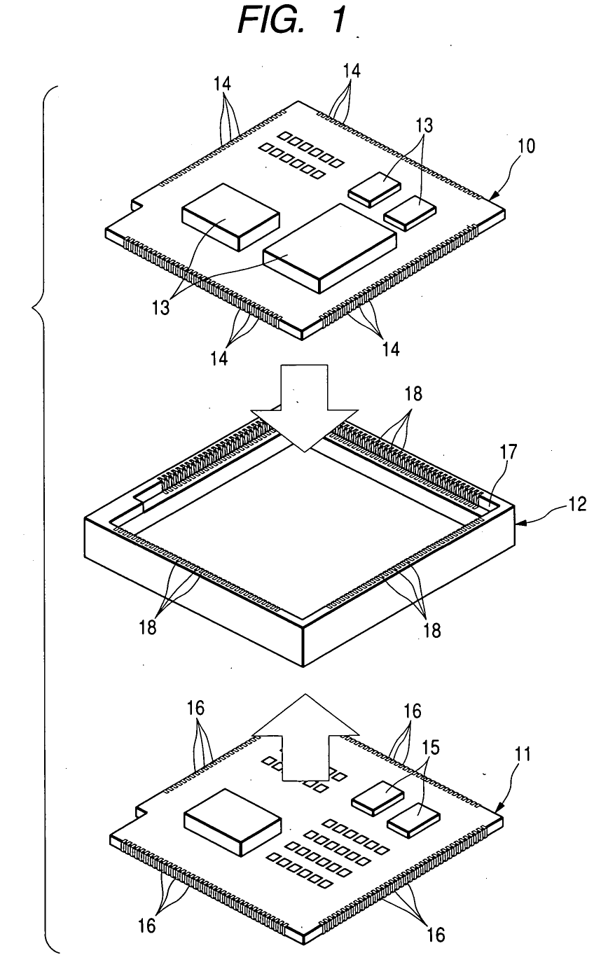

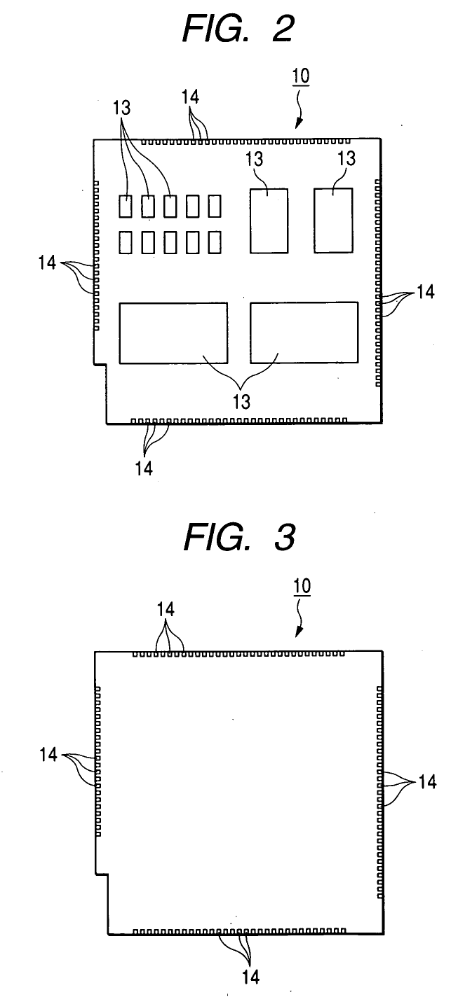

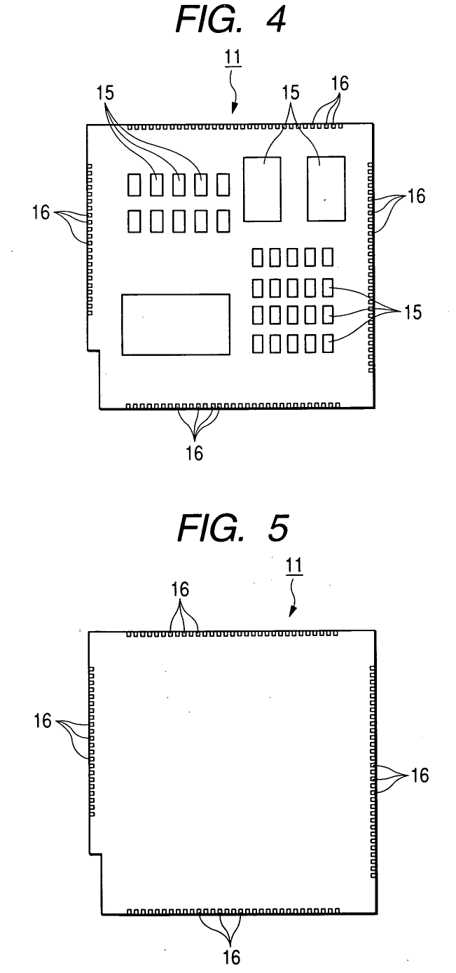

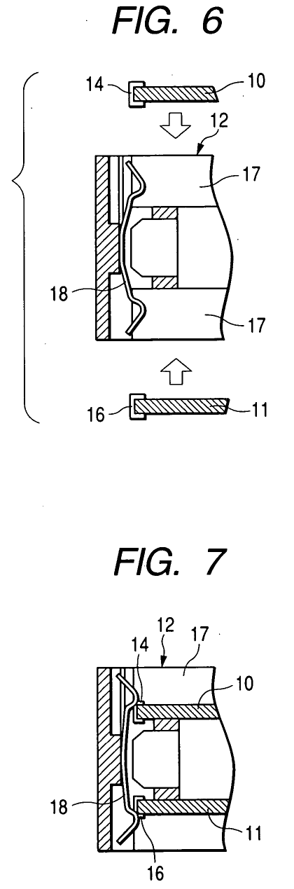

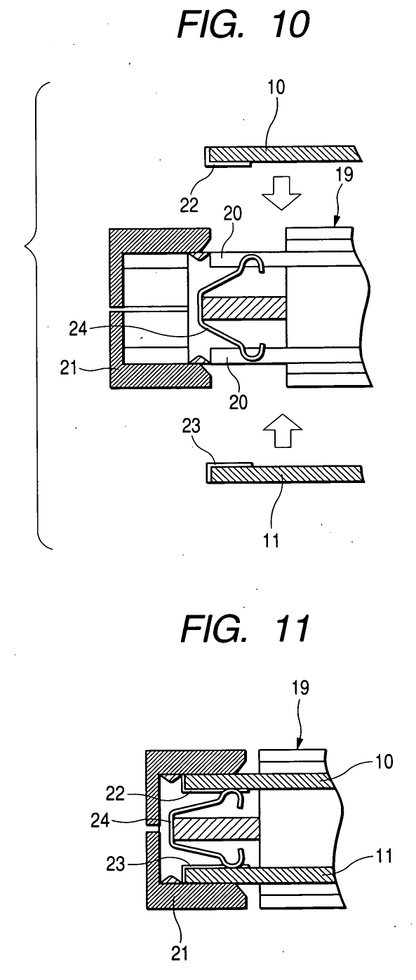

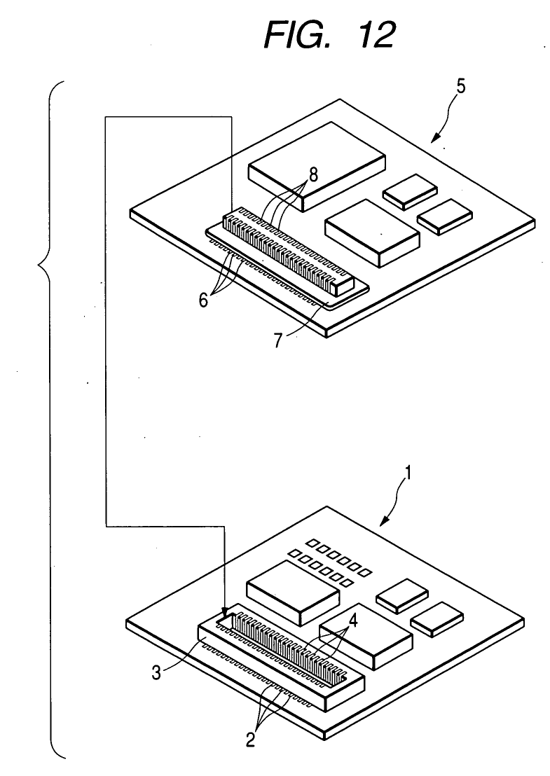

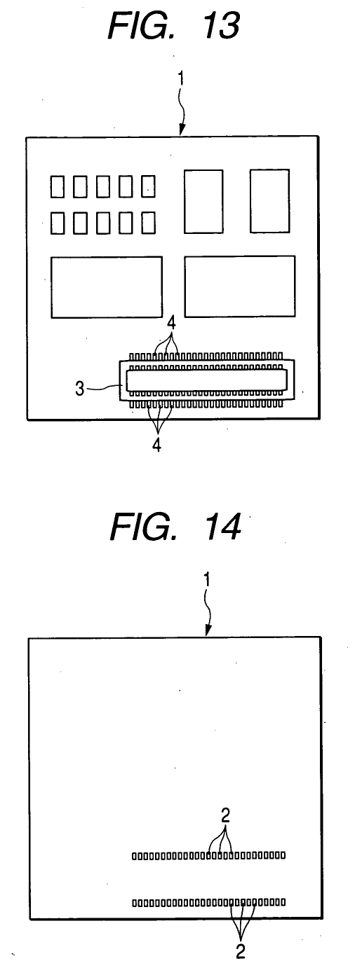

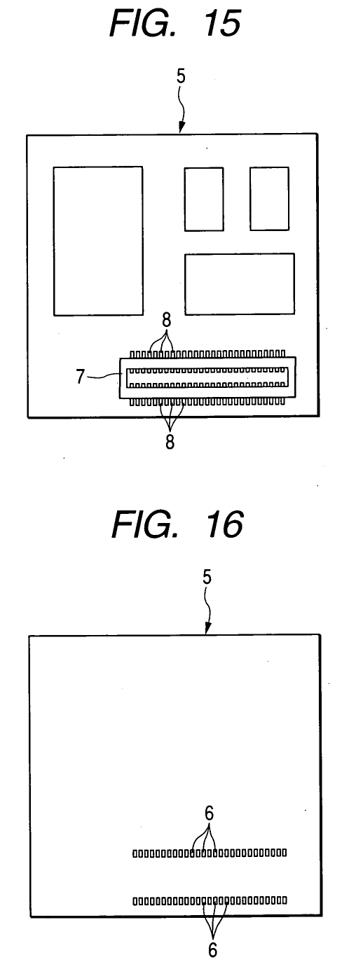

Preferred embodiments of the present invention will now be described in detail with reference to FIGS. 1 to 11. FIG. 1 is an exploded, perspective view of an assembly including a first circuit board 10, a second circuit board 11 and a connector 12 of the first embodiment. Various electronic components 13 are mounted on the first circuit board 10. Also, wiring is provided on the first circuit board 10. As shown in FIGS. 1 to 3, patterns 14 are provided at outer edge portions of the first circuit board 10.

Like the first circuit board 10, various electronic components 15 are mounted on the second circuit board 11 and also, patterns 16 are provided at outer edge portions of the second circuit board 11 as shown in FIGS. 1, 4 and 5.

On the other hand, the connector 12 is made of a synthetic resin, and recess portions 17 are formed respectively in front and back (opposite) sides of the connector as shown in FIGS. 1, 6 and 7. The recess portions 17 are generally equal in shape to the outer peripheral edge of the first and second circuit boards 10 and 11, and the first and second circuit boards 10 and 11 can be fired to the recess portions 17, respectively. Terminals 18, 18, . . . are mounted on an outer peripheral edge portion of the connector 12, and extend through the upper and lower recess portions 17.

For electrically connecting the first circuit board 10 and the second circuit board 11 together, the first and second circuit boards 10 and 11 are fitted respectively into the upper and lower recess portions 17 or the connector 12, and are fixed thereto. At this time, the patterns 14 on the first circuit board 10, as well as the patterns 16 on the second circuit board 11, are press-contacted with the terminals 18 of the connector 12, respectively, so that the first circuit board 10 and the second circuit board 11 are electrically connected together. Therefore, the step of soldering the connector 12 to the first and second circuit board 10 and 11 as in the related structure is not necessary, and besides an operation for positioning the first circuit board 10 and the second circuit board 11 relative to each other is not necessary. Therefore, this assembling operation is simplified, so that the required labor can be reduced, and this also contributes to the reduction of the cost.

Also, the patterns 14 are provided at the outer peripheral edge portion of the first circuit board 10, while the patterns 16 are provided at the outer peripheral edge portion of the second circuit board 11. Therefore, as compared with the related construction in which the patterns are provided in a concentrated manner at the one aide portion of each of the circuit boards, limitations on the design of the first and second circuit boards 10 and 11, are eliminated. Therefore, the design or the first and second circuit boards 10 and 11 can be simplified, and this also contributes to a small-size design or the first and second circuit boards 10 and 11.

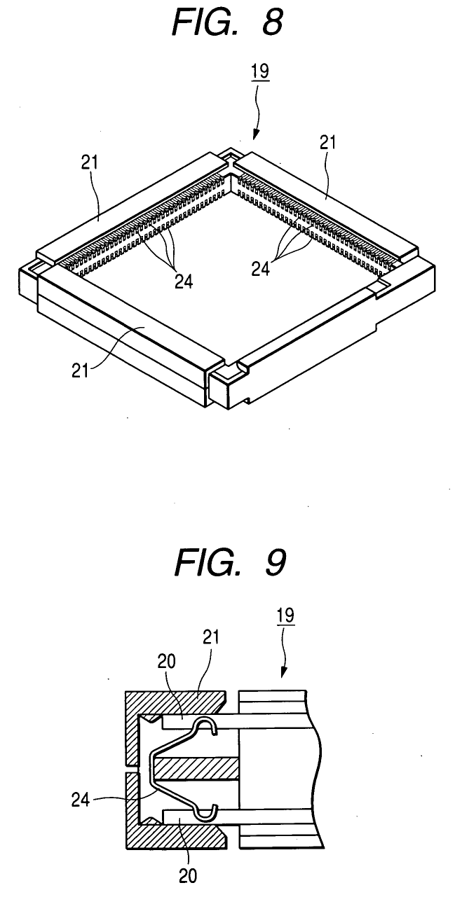

Next, FIGS. 8 to 11 show the second embodiment of the invention. In the embodiment, covers 21 are attached to a connector 19 so as to slide inwardly and outwardly (a sliding direction as shown in FIG. 9 to 11) on a peripheral edge portion of the connector 19. The covers 21 can open and close four side edge portions of each of recess portions 20 of the connector 19, respectively. For fixing the first and second circuit boards 10 and 11 to the connector, first, the covers 21 are opened. Then, the first and second circuit boards 10 and 11 are fitted in the recess portions 20, respectively, and the covers 21 are slid inwardly. As a result, each of the four side edge portions of each of the first and second circuit boards 10 and 11 is held between the edge portion of the connector 19 and a corresponding inner surface of the corresponding cover 21, and therefore the first and second circuit boards 10 and 11 are fixed to the connector 19.

At this time, patterns 22 on the first circuit board 10, as well as patterns 23 on the second circuit board 11, are press-contacted with terminals 24 of the connector 19, respectively, so that the first circuit board 10 and the second circuit board 11 are electrically connected together. In this embodiment, also, a soldering operation and an operation for positioning the first circuit board 10 and the second circuit board 11 relative to each other are not necessary as described above for the preceding embodiment. Therefore, the efficiency of the operation is enhanced, and labor, required for the assembling operation, is reduced, and besides this contributes to the reduction of the cost. Also, the design of a circuit board can be simplified, and this contributes to a small-size design of the circuit board.

In the present invention, various modifications can be made without departing from the spirits of the invention, and such modifications naturally fall within the scope or the invention.

1. A connecting device, comprising:
a first circuit board, which has a first conductive pattern on an outer peripheral edge portion thereof;
a second circuit board, which has a second conductive pattern on an outer peripheral edge portion thereof; and
a connector, which has a terminal corresponding to the first and second conductive patterns,
wherein the terminal connects the first conductive pattern and the second conductive pattern when the first circuit board and the second circuit board are attached to the connector.

2. A connecting device, comprising:
a first circuit board, which has a first conductive pattern on an edge portion thereof;
a second circuit board, which has a second conductive pattern on an edge portion thereof; and
a connector, which includes a first face and a second face opposed to the first face, the first face and second race having a first recess portion and a second recess portion respectively,
wherein a terminal is provided in the first and second recess portion; and
wherein the terminal connects the first conductive pattern and the second conductive pattern when the first circuit board and the second circuit board are attached to the first recess portion and the second recess portion respectively.

3. The connecting device, as set forth in claim 2, wherein each of the first recess portion and the second recess portion has at least two sides; and
wherein a plurality of the terminals of the connector are arranged along the at least two sides.

4. The connecting device, as set forth in claim 2, wherein the connector has a step portion which prevents from insertion or the first and second circuit boards in a reverse state to the first and second recess portions.

5. The connecting device, as set forth in claim 2, wherein a thickness of each of the first and second recess portion is greater than that of each of the first and second circuit boards.

6. The connecting device, as set forth in claim 2, wherein each of the first and second circuit boards has a two linear sides which are faced with to each other and curved sides which are connected to the linear sides.

7. The connecting device, as set forth in claim 2, wherein the connector has a fixing member which fixes the first and second circuit boards to the connector.

8. The connecting device, as set forth in claim 7, wherein the fixing member is provided as a cover member;
wherein the cover member is slidably provided on an end portion of the connector;
wherein the covers slides between an open position and a closed position;
wherein when the cover member is positioned at the open position, the cover member allows the first and second circuit boards to attach to the connector, and
wherein when the cover member is positioned at the closed position in a case that the first and second circuit board are mounted on the connector, the cover member fixes the first and second circuit boards to the connector.

9. The connecting device, as set forth in claim 8, wherein the cover member covers the first and second conductive patterns of the first and second circuit boards when the cover member is positioned at the closed position.
